(19) United States
(12) Patent Application Publication
(10) Pub. No.: US 2018/0316633 A1
(43) Pub. Date: Nov. 1, 2018

(54) AUTOMATIC DETERMINATION OF DATA ITEMS FOR A COINCIDENT EVENT

(71) Applicant: Vincent Y. Mo, Sunnyvale, CA (US)

(72) Inventor: Vincent Y. Mo, Sunnyvale, CA (US)

(73) Assignee: Google Inc., Mountain View, CA (US)

(21) Appl. No.: 13/279,191

(22) Filed: Oct. 21, 2011

(51) Int. Cl. H04L 12/58; H04W 4/21

(52) U.S. Cl. CPC H04L 51/04; H04L 51/16; H04W 4/21

(57) ABSTRACT

A system and machine-implemented method for determining whether a data item corresponds to a coincident event. Time data is received for a first data item and for a second data item. A determination is made whether the time data for the first data item corresponds to the time data for the second data item. A determination is made that the first data item and the second data item correspond to a coincident event, if the time data corresponds. Additional data is identified for the coincident event, wherein the additional data is based on at least one of the first data item or the second data item. The corresponding time data and the additional data are compared with data of a third data item. A determination is made that the third data item corresponds to the coincident event based on the comparison.

### BACKGROUND

The present disclosure generally relates to data processing, and, in particular, to automatic determination of data items for a coincident event.

Many pieces of information and media can be associated with the planning, recording, and discussion of an event. For example, in leading up to an event, calendar entries, posts within a social networking site, entails, text messages and documents (e.g., travel documents) can be used. During the event itself, photos and videos can be taken, and text messages can be exchanged. After the event has occurred, further information can be exchanged, such as social networking posts, uploads of photos, emails and text messages.

However, these pieces of data are usually spread across different users and may be saved at different locations (e.g., locally on a PC, on an email server, on a social networking server). Thus, it may be desirable to automatically recognize that an event took place, and to gather the multiple pieces of information together for presentation to a user.

### SUMMARY

The disclosed subject matter relates to a machine-implemented method for determining whether a data item corresponds to a coincident event. The method comprises receiving time data for a first data item and for a second data item, determining whether the time data for the first data item corresponds to the time data for the second data item, and determining that the first data item and the second data item correspond to a coincident event, if the time data corresponds. The method further comprises identifying additional data for the coincident event, wherein the additional data is based on at least one of the first data item or the second data item, comparing the corresponding time data and the additional data with data of a third data item, and determining that the third data item corresponds to the coincident event based on the comparison.

The disclosed subject matter further relates to a system for determining whether a data item corresponds to a coincident event. The system comprises one or more processors, and a machine-readable medium comprising instructions stored therein, which when executed by the processors, cause the processors to perform operations comprising receiving data for a first data item and for a second data item, determining whether the data for the first data item corresponds to the data for the second data item and determining that the first data item and the second data item correspond to a coincident event, if the data corresponds. The operations further comprise identifying additional data for the coincident event, wherein the additional data is based on at least one of the first data item or the second data item, comparing the corresponding data and the additional data with data of a third data item, and determining that the third data item corresponds to the coincident event based on the comparison.

The disclosed subject matter also relates to a machine-readable medium comprising instructions stored therein, which when executed by a system, cause the system to perform operations comprising receiving data for a first data item and for a second data item, and calculating a difference between the data for the first data item and the data for the second data item. The operations further comprise, if the calculated difference is less than a threshold difference, determining that the first data item and the second data item correspond to a coincident event, identifying additional data for the coincident event, wherein the additional data is based on at least one of the first data item or the second data item, comparing the data for the first and second data items, and the additional data, with data of a third data item, and determining that the third data item corresponds to the coincident event based on the comparison.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several embodiments of the subject technology are set forth in the following figures.

FIG. 1 illustrates an example network environment which provides for determining whether a data item corresponds to a coincident event.

FIG. 2 illustrates an example environment for event recognition and data item gathering.

FIG. 3 illustrates an example process by which data items corresponding to an event are clustered.

FIG. 4 illustrates an example process by which a determination is made whether a data item corresponds to a coincident event.

FIG. 5 depicts an example social graph.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter describes systems and techniques for determining whether a data item corresponds to a coincident event. A coincident event can correspond to a single event (e.g., a wedding ceremony) or to related events (e.g., a bridal shower or reception related to the wedding ceremony). For example, the data item can correspond to an image, a video, an audio message, a message or post within a social networking site, an email message, a text message, a calendar event, or a document.

Time data is received for a first data item and for a second data item. A determination is made whether the time data tor the first data item corresponds to the time data for the second data item. For example, the time data can correspond if the difference between the time data for the first data item and the second data item is less than a threshold difference. If the time data corresponds, a determination is made that the first data item and the second data item correspond to a coincident event.

Additional data is identified for the coincident event, wherein the additional data is based on at least one of the first data item or the second data item. For example, the additional data can correspond to location information (e.g., geo-location data or location data extracted from text), the identification of a person or landmark (e.g., from tagging by a user of a social networking site, reference to the person or landmark within text or audio content, or if the person is a participant of a communication message).

The corresponding time data and the additional data are compared with data of a third data item. The first, second and third data items can be of the same data type (e.g., images) or of different data types (e.g., image, text message, video). In addition the first, second and third data items can be associated with different sources. A determination is made that the third data item corresponds to the coincident event based on the comparison.

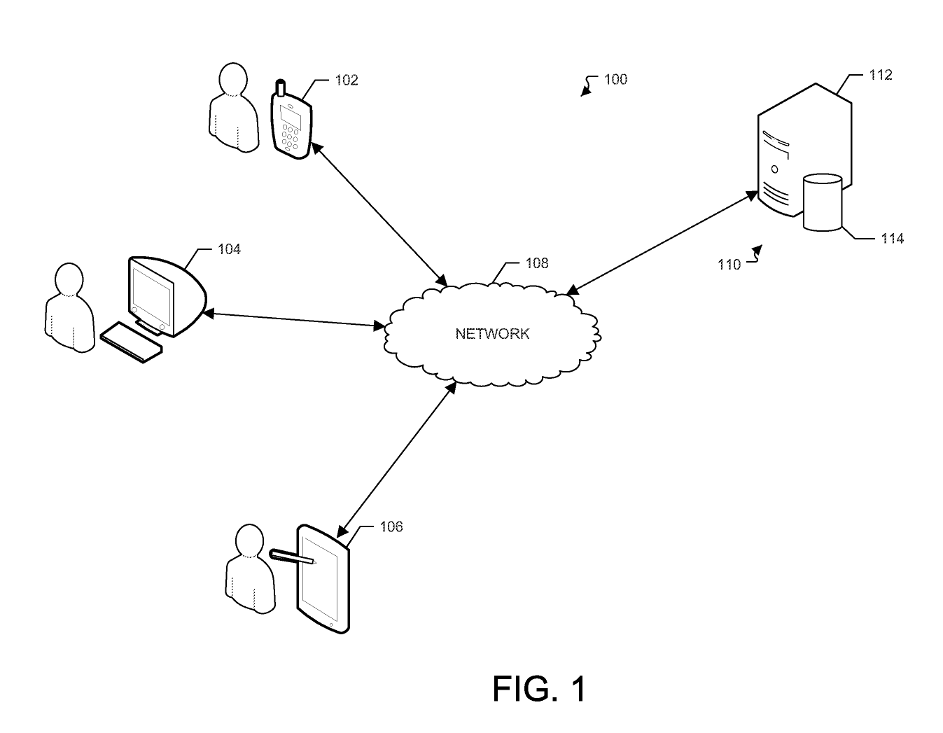

FIG. 1 illustrates an example network environment which provides for determining whether a data item corresponds to a coincident event. A network environment 100 includes computing devices 102,104 and 106, and a computing system 110. Computing devices 102 to 106 and computing system 110 can communicate with each other through a network 108. Computing system 110 can include one or more computing devices 112 (e.g., one or more servers) and one or more computer-readable storage devices 114 (e.g., one or more databases).

Each of computing devices 102 to 106 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 102 to 106 and 112 may be provided access to and/or receive application software executed and/or stored on any of the other computing systems 102 to 106 and 112. Computing device 112 can represent various forms of servers including, but not limited to a web server, an application server, a proxy server, a network server, or a server farm.

In some aspects, the computing devices may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 108. Network 108 can be a large computer network, such as a local area network (LAN), wide area network (WAN), the Internet, a cellular network, or a. combination thereof connecting any number of mobile clients, fixed clients, and servers. In some aspects, each client (e.g., computing devices 102, 106) can communicate with servers (e.g., computing device 116) via a virtual private network (VPN), Secure Shell (SSH) tunnel, or other secure network connection. In some aspects, network 108 may further include a corporate network (e.g., intranet) and one or more wireless access points.

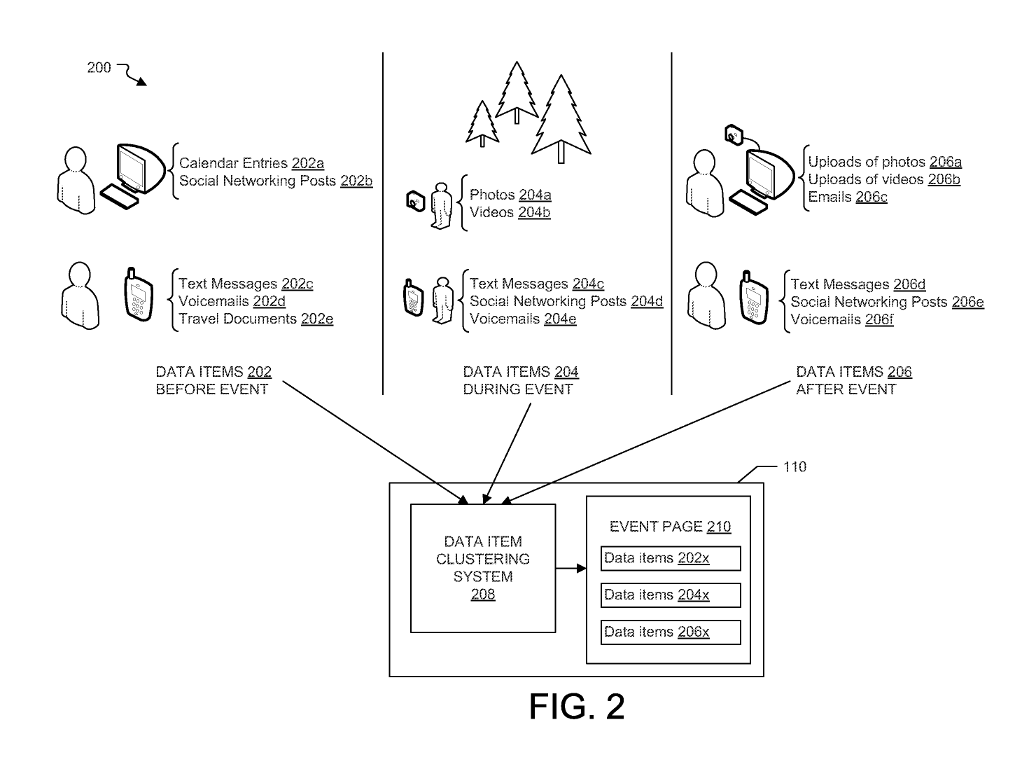

FIG. 2 illustrates an example environment for event recognition and data item gathering. As noted above, many pieces of information and media can be associated with the planning, recording, and discussion of an event. The example environment 200 of FIG. 2 illustrates how these pieces of information may be clustered together and presented within an event page 210, using a data item clustering system 208.

As can be seen in FIG. 2, data items 202 correspond to data items generated before an event, data items 204 correspond to those generated during the event, and data items 206 correspond to those generated after the event. For example, data items 202 can include calendar entries 202, and social networking posts 202b associated with one user, and text messages 202c, voicemails 202d and travel documents 202e associated with another user. Data items 204 can include photos 204a and videos 204b associated with one user, and text messages 204c, social networking posts 204d and voicemails 204e associated with another user. Data items 206 can include uploaded photos 206a, uploaded videos 206b and emails 206c associated with one user, and text messages 206d, social networking posts 206e and voicemails 206f associated with another user.

As seen in FIG. 2, data items 202 to 206 can be generated by users using different electronic devices. All users before, during and after the event may be similar, or may be different users. For example, the user associated with data items 202a-202b may not be the same as the user associated with data items 204a-204b, or the user associated with data items 206a-206c, In another example, the same user can be associated with data items 202a-202b, 204a-204b and 206a-206c.

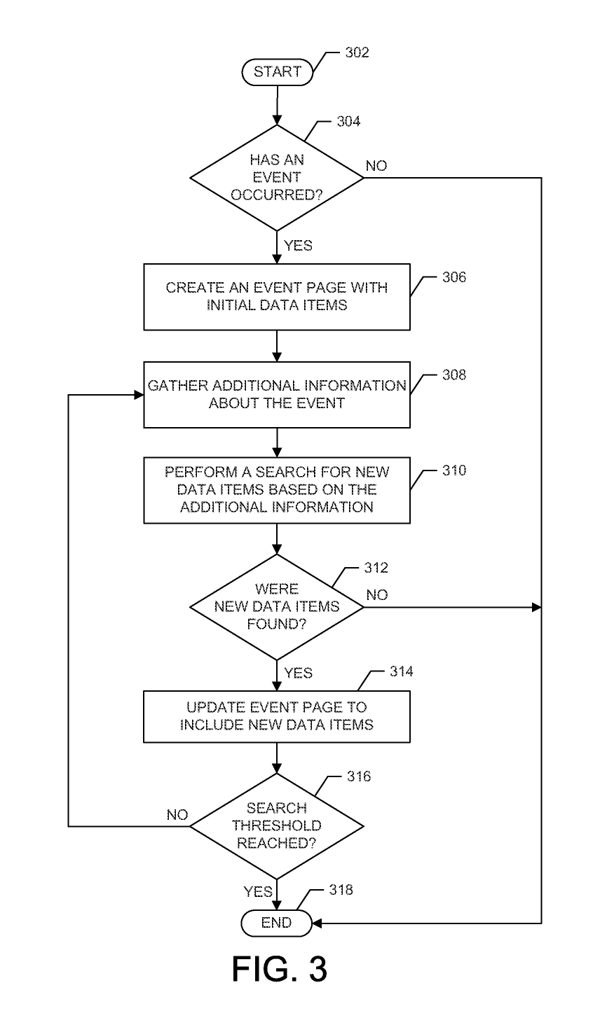

Data item clustering system 208 can be used for clustering data items 202, 204 and 206, and providing the clustered data (e.g., as data items 202x, 204x and 206x) to an event page 210. For example, data clustering system 208 can be used to seed an event, gather additional information about the event, and broaden a search to find additional data items for the event, as will be described in greater detail below with respect to FIG. 3.

FIG. 3 illustrates an example process by which data items corresponding to an event are clustered. For example, the data items can correspond to any of data items 202 to 206 of FIG. 2. Following start block 302, an inquiry is made as to whether an event has occurred at decision step 304. To determine if an event has occurred, data clustering system 208 can compare data associated with data items 202 to 206, to check for correspondence between the data. For example, comparisons by one or more of time, location and content between data items 202 to 206 can be made, to determine if an event has occurred.

As noted above, data items 202 to 206 can correspond to calendar entries, social networking posts, text messages, voicemails, travel documents, photos, videos, mails, or any item associated with the event. In addition to including the content itself (e.g., the image data of a photo, the text data of an email), each of data items 202 to 206 can include other data which can be used to contextualize the data item. Examples of such other data include timestamp data and geo-location data (e.g., for data items that are photos, digital cameras can store time and location information with the photos). The timestamp data can correspond to when a particular data item was generated, and the geo-location data can correspond to where a particular data item was generated. The timestamp and geo-location can be associated with the particular data item as metadata by, for example, a smart phone that stores with the data item the time and location of the smart phone when the data item was generated. Data clustering system 208 can compare the timestamp and geo-location data of the data items.

In addition, data clustering system 208 can obtain further content related to data items 202 to 206. For example, users of electronic devices 102 to 106 can tag photos (e.g., in a social networking site), thereby providing identities of people, places or items in the photos. Data clustering system 208 can also use facial recognition techniques to identify people in photos. Data clustering system 208 can also detect recognizable landmarks in the photos, such as famous buildings or other unique backgrounds.

For text-based data items (e.g., documents, emails, social networking posts, text messages), data clustering system 208 can also obtain the identity of people, places or items based on the text content. For example, the text-based data items can be searched for times, people, places or items. In some aspects, natural language processing (NLP) techniques, such as term frequency-inverse document frequency (tf-idf) weight analysis, can be performed on text-based data items to identify times, people, places or items. Furthermore, for audio-based data items (e.g., voicemails), data clustering system 208 can obtain the identity of people, places or items from the audio data. For example, the audio data can be converted to text data, which can then be searched, or can be processed using NLP techniques as mentioned above.

As such, data clustering system 208 can gather data items in multiple data formats. It should be further be noted that data clustering system 208, with proper permissions, can gather the data items from different resources. For example, the data items can be collected from one or more social networking sites or other websites/applications (e.g., running on computing system 110). In addition, the data items can be collected from other electronic devices (e.g., any of electronic devices 102 to 106) using the appropriate application interfaces (APIs). Thus, with proper permissions, data clustering system 208 can obtain data items from one or more resources storing the data items.

Data clustering system 208 can compare data between different data items to detect coincident elements between the data items. When data clustering system 208 detects coincident elements, data clustering system 208 can determine that the data, items are of the same event. For example, data clustering system 208 can determine that data items 204a and 204b are of the same event, if the data associated with data items 204a and 204b indicates that they were generated at approximately the same time and/or near the same location. Data clustering system 208 can use the timestamp data to determine the time each data item was generated. In this regard, use of time data to seed the event may be more applicable for data items 204, which occur during the event itself.

For example, data clustering system 208 can include a threshold amount of time that is used to determine whether data items 204a and 204b are deemed to have been taken at approximately the same time. Data clustering system 208 can determine that data items 204a and 204b were taken within the threshold amount of time of each other are close enough in time that data items 204a and 204b might be of the same event. For example, a difference between a timestamp of data item 204a and a timestamp of data item 204b can be determined. If the difference is less than Or equal to the threshold amount of time, data items 204a and 204b can be deemed to have been taken at approximately the same time. Of course, data items 204a and 204b correspond to one example of comparing data items based on time, and other data items can be compared (e.g., any of data items 204a-204e). If the difference is greater than the threshold amount of time, the data items (e.g., data items 204a and 206a) can be deemed to have not beets taken at approximately the same time.

Data clustering system 208 can also compare location data between different data items to detect coincident elements between the data items. In this regard, data clustering system 208 can determine whether at least a particular person is identified in each of the data items, whether a particular landmark is identified in each of the data items, and/or whether respective geo-locations of the data items correspond to one another. For example, if two data items each identify a particular person and were generated at the same or approximately the same time (as discussed above), the data items can be deemed to have been generated at the same or approximately the same location. As another example, if a particular landmark (e.g., a building, a statue, a monument) is identified by each of the data items, the data items can be deemed to have been generated at the same or approximately the same location.

As another example, geo-location data of the data items can indicate that the data items were generated at the same or approximately the same location. Use of geo-location data to seen the event may be more applicable for data items 204, which occur during the event itself. In this regard, data clustering system 208 can use a threshold distance of the respective geo-locations of the data items. If the distance between the geo-locations is less than the threshold distance, the data items can be considered as having been generated at the same or approximately the same location. For example, a difference between a geo-location of data item 204a and a geo-location of data item 204c can be determined, If the difference is less than or equal to the threshold. distance, data items 204a and 204c can be deemed to have been generated at approximately the same location. If the difference is greater than the threshold distance, the data items (e.g., data items 204a and 206e) can be deemed to have not been generated at the same location.

As can be seen in FIG. 3, if the answer to the inquiry at decision step 304 is no, the process ends at end block 318. If the answer to the inquiry is yes, an event page is created with the initial data items (e.g., data items 202a and 202b) at step 306. Event page 210 can include a webpage corresponding to the coincident event, and the initial data items can be presented within the event page (e.g., upon approval of the owner of the data items). For example, if the initial data items correspond to photos, the photos can be published to the event page. The event page 210 can be a webpage provided by a social networking service, or by another website or application.

Event page 210 can include privacy settings that allow only some users to view the page. For example, if the event page is provided by a social networking service, viewing of the event page 210 can be limited only to the social networking contacts of the users whose data items are included on the event page 210. Event page 210 can include further privacy settings which limit what data items can be viewed, based on the user viewing event page 210. For example, if a particular user was part of an text message conversation, that user can view the conversation within event page 210. However, if the user was not part of the text message conversation, it is possible to prevent the user from viewing the conversation within event page 210. Of course, other privacy settings can be used. In some implementations, the event page 210 can be generated by a user. For example, user 104 can generate the event page 210 using a social networking service and can provide data items for display within the event page 210.

At step 308, additional information is gathered about the event. This additional information can be gathered from the data items which were compared in decision step 304, using additional data of those data items. As noted above, data clustering system 208 can obtain content related to data items 202 to 206. For photos, data clustering system 208 can identify people, places or landmarks (e.g., via tagged photos, facial recognition). For text-based and audio-based data items, data clustering system 208 can also identity people, places or items.

For example, if timestamps of data items 204a and 204b were compared in decision step 304, and the determination was made that data items 204a and 204b correspond to a coincident event, additional data can be gathered from one or more of data items 204a and 204b. This additional data can include, for example, location data or the identify of people, places or things (e.g., which were tagged or otherwise referenced in the data items).

At step 310, a search is performed for new data items based on the additional information. For example, if timestamps were used to determine that data items 204a and 204b correspond to a coincident event, and additional geo-location data and the identify of people were obtained from data items 204a and 204b, a further search can be performed for new data items which match the timestamps and which match the additionally obtained geo-location data and/or the identity of people. For example, if data items 204a and 204b were initially compared with each other, and additional information for these items was gathered in step 306, the new data items resulting from the search in step 308 may include data items 204c to 204e.

At decision step 312, an inquiry is made as to whether new data items were found. If the answer to the inquiry at decision step 312 is yes, event page 210 is updated to include the new data items at step 314. For example, data clustering system 208 can automatically update event page 210 to include the new data items. Alternatively, data clustering system 208 may update event page 210 upon permission from the creator of the event page and/or permission from the owners of the new data items. For example, the owners of the new data items can be notified of the existence of the event page 210, and can provide permission to add their data items to event page 210. In this manner, the new data items can be displayed on event page 210.

In some aspects, the owners of the new data items can provide the data items directly to event page 210. Further, notifications can be used to confirm that the data items determined to be of a coincident event do, in fact, coincide with the event. For example, a user may receive a notification that event page 210 has been created and that the user's data items may correspond to the event associated with event page 210. The user can provide feedback indicating that the user's data items do not correspond to the event associated with event page 210. In this manner, it is possible for data clustering system 208 to process the feedback to further improve the accuracy of coincident event detection.

At decision step 316, an inquiry is made as to whether a search threshold has been reached. The search threshold can indicate that a sufficient number of data items have been gathered for the coincident event. For example, the search threshold can correspond to a preset value, a user-adjustable value or a value based on display size. If the answer to this inquiry is yes, the process returns to step 308. Otherwise, the process ends at end block 318.

Thus, as can be seen in FIG. 3, the process continues to gather additional information in step 308, to perform searches for new data items based on the additional information in step 310, and to update the event page with new items in step 314, until no new items are found in decision step 312 or until the search threshold is reached in decision step 316.

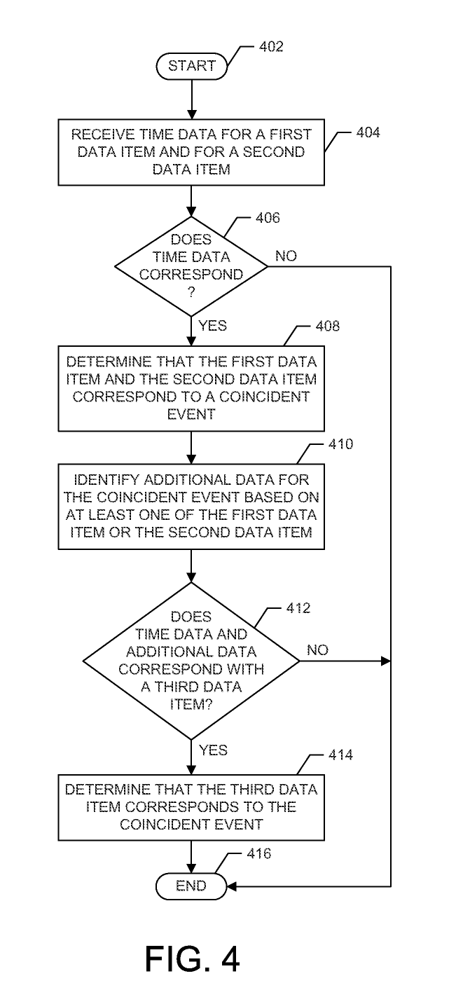

FIG. 4 illustrates an example process by which a determination is made whether a data item corresponds to a coincident event. Following start block 402, time data is received for a first data item and for a second data item at step 404. For example, the first and second data items can be received by data clustering system 208. The first and second data items can include data such as content data, timestamp data and geo-location data. The first and second data items can also include ancillary data that can include tags or labels of people, objects, and/or locations in the content and/or a time and date of the data item.

At decision step 406, a determination is made as to whether the time data timestamp) for the first data item corresponds to the time data for the second data item. For example, data clustering system 208 can perform a comparison between a timestamp of the first data item and a timestamp of the second data item, and determine if the timestamps are within a threshold amount of time of each other. If the answer to the inquiry at decision step 406 is no, the process ends at end block 416. If the answer to this inquiry is yes, then a determination is made that the first data item and the second data item correspond to a coincident event at step 408.

At step 410, additional data is identified for the coincident event. The additional data is based on at least one of the first data item and the second data item. For example, users associated with the first and second data items can tag photos (e.g., in a social networking site) of people thereby providing identities of people, places or items in the photos. Data clustering system 208 can obtain these identifies with proper user permissions. Data clustering system 208 can also use facial recognition techniques to identify people in photos, with proper user permissions. Data clustering system 208 can also detect recognizable landmarks in the photos, such as famous buildings or other unique backgrounds.

For text-based data items, data clustering system 208 can obtain the identity of people, places or items from the text content with proper user permissions. The text-based data items can be searched for times, people, places or items. NLP techniques can also be performed on text-based data items to identify times, people, places or items, as mentioned above. For audio-based data items (e.g., voicemails), computing system 110 can obtain the identity of people, places or items from the audio data with proper user permissions. For example, the audio data can be converted to text data, which can then be searched and/or processed using NLP techniques.

At decision step 412, an inquiry is made as to whether the corresponding time data and the additional data correspond with data of a third data item. If the answer to this inquiry is no, the process ends at end block 416. If the answer to this inquiry is yes, a determination is made that the third data item corresponds to the coincident event based on the comparison at step 414, and the process ends at end block 416.

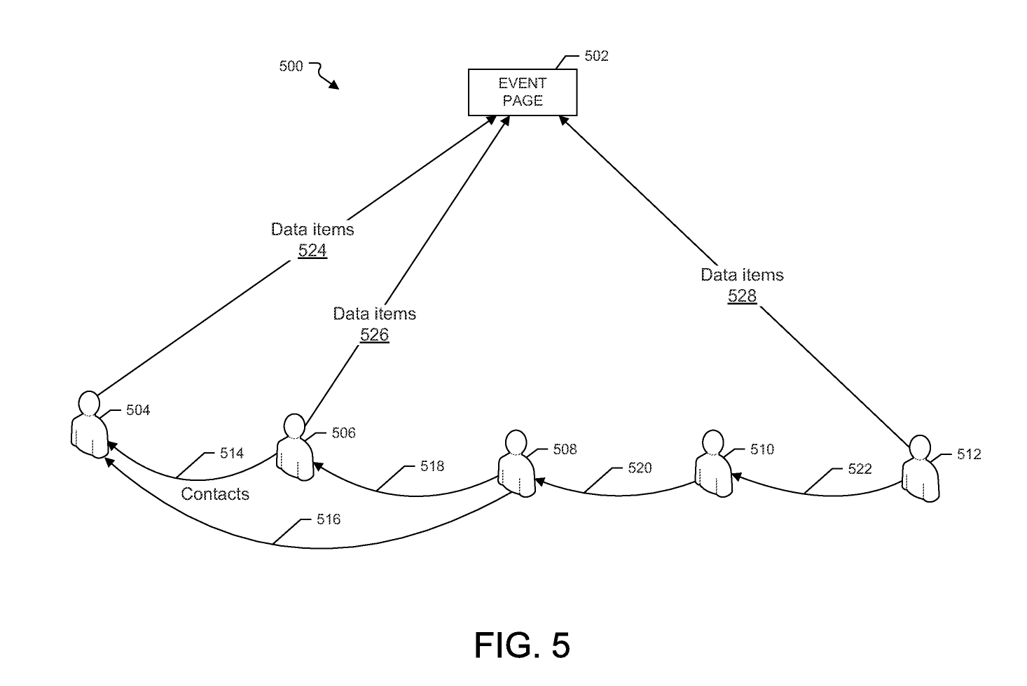

FIG. 5 depicts an example social graph 500. As noted above, the automatic detection of data items for a coincident event as described herein can apply, at least partially, to data items within a social networking site. The example social graph 500 corresponds to a user 504. Social graph 500 can be determined based on user 504's use of a computer-implemented social networking service. For example, user 504 can generate a profile within the social networking service and can digitally associate the profile with profiles of other users of the social networking service. User 504 can upload data items that can be published using the social networking service. In the example social graph 500 of FIG. 5, other users of the social networking service include user 506, user 508, user 510 and user 512. User 506 and user 508 are both contacts of user 504 within the social networking service, as indicated by connections 514 and 516, respectively. User 508 is a contact of user 506 as indicated by connection 518, user 510 is a contact of user 508 as indicated by connection 520, and user 512 is a contact of user 510 as indicated by connection 522. For example, user 504 may have previously approved user 506 and user 508 as contacts in the social networking service, such that information and/or data items provided by user 504 may be automatically shared with user 506 and user 508. Likewise, previous approval can have occurred for the other contacts of the other users.

In the example social graph 500 of FIG. 5, user 510 is not a contact of user 504 within the social networking service. Instead, user 510 may be another user of the social networking service that has limited access to the information and/or posts provided by user 504. User 512 is a contact of user 510, as indicated by the connection 522, but is not a contact of user 504, user 506 or user 508.

In the example social graph of FIG. 5, user 504 has uploaded data items 524 of an event. For example, the event can be hosted by user 508 and user 510. The system can create an event page 502. In some aspects, event page 502 may include a privacy setting, set by user 504 as the first user who uploaded data items 524 of the event, which enables users of the social networking service to view and comment on event page 502. In some aspects, user 504 is able too establish a privacy setting of an event page such that only contacts of user 504 within the social networking service, or a subset of contacts of user 504 within the social networking service, are able to view and comment on event page 502.

The system can also find data items of user 506 by searching through user 504's social contacts. In addition, the system can identify data items 526, which represent the portion of user 506's data items (e.g., all data items, a subset of data items) which correspond to the event. The system can notify user 504 that user 506 has uploaded data items 526 of the event. The system can also notify user 506 that user 504 has created event page 502 for the data items of the event. With proper permissions from one or both of user 504 and user 506, the system can include data items 524 and/or data items 526 on event page 502.

The system can also find user 512's data items 528 of the event, even though neither user 504 nor user 506 are contacts of user 512. For example, data items 528 can include pictures and videos of user 508 and user 510, who hosted the event. The system can then search through user 508 and user 510's contacts to determine if any of the data items they uploaded are also of the event. The system can therefore find user 512's data items of the event, and notify user 512 of event page 502. The system can also notify user 504 to request permission to include user 512's data items in the event page. In some aspects, the system can request permission from both user 504 and user 506. Of course, alternative permission and privacy settings can be used for event page 502.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

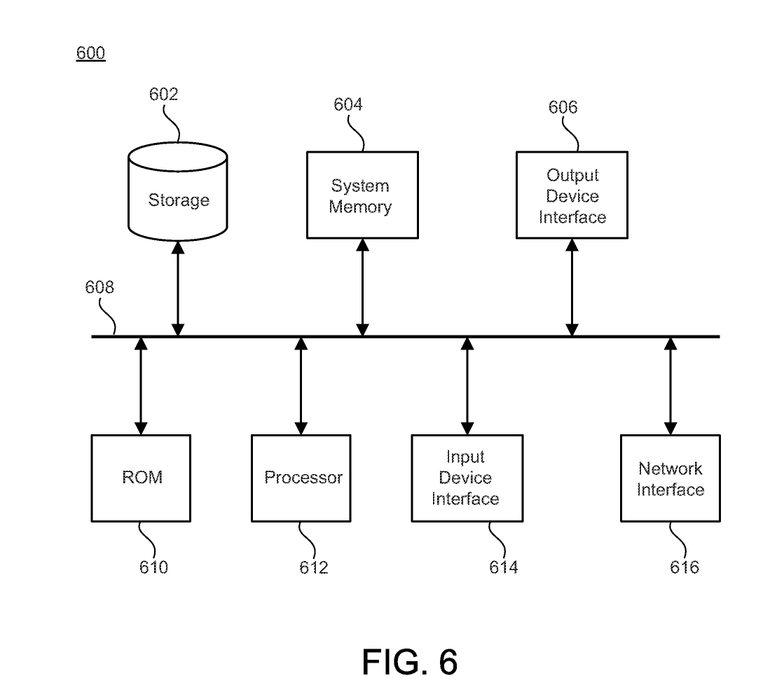

FIG. 6 conceptually illustrates an example electronic system with which some implementations of the subject technology are implemented. Electronic system 600 can be a computer, phone, PDA, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a nonvolatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for automatically determining data items for a coincident event in accordance with some implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A machine-implemented method comprising:
receiving data for a first text-based data item and for a second text-based data item, each of the first text-based data item and the second text-based data item comprising text corresponding to past social event content, the data being extracted from the text;
determining that the data for the first text-based data item corresponds to the data for the second text-based data item;
determining, in response to determining that the data for the first text-based data item corresponds to the data for the second text-based data item, that the past social event content for the first text-based data item and the past social event content for the second text-based data item correspond to a coincident social event in the past;
identifying additional data for the coincident social event, wherein the additional data comprises an identification of a user from both of the first text-based data item and the second text-based data item;
responsive to identifying the user from both of the first text-based data item and the second text-based data item, determining a contact of the user and identifying a third data item comprising past social event content generated by the contact of the user, the third data item being distinct from the first and second text-based data items;
comparing the data corresponding to the first and second text-based data items to data of the third data item comprising the past social event content generated by the contact of the user; and
determining that the past social event content for the third data item corresponds to the coincident social event based on the comparison.

2. (canceled)

3. The method of claim 1, wherein the past social event content for each of the first and second text-based data items corresponds to at least one of a message or a post within a social networking site, an email message, a text message, a calendar event, or a document, and wherein the past social event content for the third data item corresponds to at least one of an image, a video, an audio message, another message or another post within the social networking site, another email message, another text message, another calendar event, or another document.

4. The method of claim 3, wherein the first text-based data item, second text-based data item, and third data item are of different data types, or wherein the first text-based data item, second text-based data item, and third data item are associated with different sources.

5. The method of claim 1, wherein the coincident social event corresponds to a single social event or to related social events.

6. The method of claim 1, wherein the additional data corresponds to location information, and wherein the location information is based on location data extracted from text.

7. The method of claim 1, wherein the additional data corresponds to the identification of the user from both the first and second text-based data items, and wherein the identification of the user is based on tagging by another user of a social networking site, reference to the user within text, or participants of communication messages corresponding to one of the first text-based data item, second text-based data item.

8. The method of claim 1, wherein the additional data further corresponds to an identification of at least one landmark, and wherein the identification of the at least one landmark is based on tagging by another user of a social networking site, or reference to the at least one landmark within text.

9. The method of claim 1, wherein the additional data is obtained using natural language processing techniques performed on both of the first text-based data item and the second text-based data item.

10. The method of claim 1, wherein the identifying the additional data, the comparing, and the determining that the past social event content for the third data item corresponds to the coincident social event are repeated to identify additional items corresponding to the coincident social event.

11. (canceled)

12. A system comprising:
one or more processors; and
a machine-readable medium comprising instructions stored therein, which when executed by the processors, cause the processors to perform operations comprising:
receiving data for a first text-based data item and for a second text-based data item, each of the first text-based data item and the second text-based data item comprising text corresponding to past social event content, the data being extracted from the text;
determining that the data for the first text-based data item corresponds to the data for the second text-based data item;
determining, in response to determining that the data for the first text-based data item corresponds to the data for the second text-based data item, that the past social event content for the first text-based data item and the past social event content for the second text-based data item correspond to a coincident social event in the past;
identifying additional data for the coincident social event, wherein the additional data comprises an identification of at least one person from the first text-based data item and the second text-based data item;
comparing the data corresponding to the first and second text-based data items to data of a third data item comprising past social event content generated by a contact of the at least one person identified from the first and second text-based data items; and
determining that the past social event content for the third data item corresponds to the coincident social event based on the comparison.

13. (canceled)

14. The system of claim 12, wherein the past social event content for each of the first and second text-based data items corresponds to at least one of a message or a post within a social networking site, an email message, a text message, a calendar event, or a document, and wherein the past social event content for third data item corresponds to at least one of an image, a video, an audio message, another message or another post within the social networking site, another email message, another text message, another calendar event, or another document.

15. The system of claim 12, wherein the additional data corresponds to location information, and wherein the location information is based on location data extracted from text.

16. The system of claim 12, wherein the identification of the at least one person is based on tagging by a user of a social networking site, reference to the at least one person within text, or participants of communication messages corresponding to one of the first text-based data item, second text-based data item, or third data item.

17. The system of claim 12, wherein the additional data further corresponds to an identification of at least one landmark, and wherein the identification of the at least one landmark is based on tagging by a user of a social networking site, or reference to the at least one landmark within text.

18. The system of claim 12, wherein the additional data is obtained using natural language processing techniques.

19. The system of claim 12, wherein the identifying the additional data, the comparing, and the determining that the past social event content for the third data item corresponds to the coincident social event are repeated to identify additional items corresponding to the coincident social event.

20. A non-transitory machine-readable medium comprising instructions stored therein, which when executed by a system, cause the system to perform operations comprising:
receiving data for a first data item and for a second data item, each of the first data item and the second data item corresponding to past social event content;
calculating a difference between the data for the first data item and the data for the second data item;
determining, if the calculated difference is less than a threshold difference, that the past social event content for the first data item and the past social event content for the second data item correspond to a coincident social event in the past;
identifying additional data for the coincident social event, wherein the additional data comprises an identification of a user from at least one of the first data item or the second data item;
comparing the data for the first and second data items to data of a third data item comprising past social event content generated by a contact of the user identified from the first and second data items; and
determining that the past social event content for the third data item corresponds to the coincident social event based on the comparison.

21. The non-transitory machine-readable medium of claim 20, wherein the past social event content for each of the first and second data items corresponds to at least one of a message or a post within a social networking site, an email message, a text message, a calendar event, or a document, and wherein the past social event content for the third data item corresponds to at least one of an image, a video, an audio message, another message or another post within the social networking site, another email message, another text message, another calendar event, or another document.

22. The non-transitory machine-readable medium of claim 20, wherein the additional data corresponds to location information, and wherein the location information is based on location data extracted from text.

23. The non-transitory machine-readable medium of claim 20, wherein the identification of the user is based on tagging by another user of a social networking site, reference to the user within text, or participants of communication messages corresponding to one of the first, second or third data items.

24. The method of claim 1, further comprising:
generating an event page for displaying content of plural data items that correspond to the coincident social event, wherein the plural data items include the first and second text-based data items and the third data item.

25. The method of claim 24, wherein for each of the respective plural data items:
the respective data item is associated with one or more users, and
access to the respective data item is limited to the one or more users associated with the respective data item.

26. The method of claim 25, wherein generating the event page comprises receiving permission from each of the one or more users associated with the respective data item to add the respective data item to the event page.

27. The non-transitory machine-readable medium of claim 20, wherein the first and second data items comprise first and second images, respectively, and the user is identified in both of the first and second images.
